(19) United States
(12) Patent Application Publication
(10) Pub. No.: US 2025/0198543 A1
(43) Pub. Date: Jun. 19, 2025

(54) DUCT ASSEMBLY, METHODS OF MANUFACTURE AND USE THEREOF

(71) Applicant: EMTELLE UK LIMITED, Hawick (GB)

(72) Inventor: William George RAE, Hawick (GB)

(73) Assignee: EMTELLE UK LIMITED, Hawick (GB)

(21) Appl. No.: 18/982,061

(22) Filed: Dec. 16, 2024

(30) Foreign Application Priority Data
Dec. 14, 2023 (GB) 2319191.9

(51) Int. Cl. F16L 9/12; F16L 1/028; F16L 1/11; F16L 9/133

(52) U.S. Cl. CPC F16L 9/125; F16L 1/028; F16L 1/11; F16L 9/133

(57) ABSTRACT

A duct assembly comprises a duct having an outer wall of polymer material, an insulating jacket coupled to the pipe, and a tracer wire within the insulating jacket. The insulating jacket is generally round in cross-section and is attached directly to the outer wall of the duct without the use of adhesive. The insulating jacket and tracer wire can be peeled as a unit from the outer surface of the duct. The insulating jacket is made of a thermoplastic polymer material and is attached to the outer wall of the duct by pressing together the outer wall of the duct and the insulating jacket while the polymer material of the insulating jacket is at or close to its melting point. The duct assembly can be made in a single continuous process. Methods of manufacture and use are disclosed.

### FIELD OF THE INVENTION

The present invention relates to assemblies including non-metallic ducts, including plastic microducts and larger ducts that may be buried in the ground or installed within larger ducts. The invention further relates to methods of manufacturing such cables and methods of installation of cables in a duct.

### BACKGROUND TO THE INVENTION

Optical fibre cables and power cables can be installed through buried ducts. Lightweight optical fibre cables have proven extremely successful in delivering optical fibre connections to large and small premises in an economic manner. Miniature cables can be installed in so-called microducts to individual homes or utility installations. Larger cables can be installed in larger ducts. These ducts and cables can be installed in advance beneath the ground, either singly or in bundles, to be populated with cables at a later date.

Where the duct is non-metallic, and even a cable already within the duct may be non-metallic, a problem is how to locate the buried duct for subsequent work. To this end, buried ducts are often provided in a duct assembly including a small electrical conductor, referred to as a “tracer wire”, running in parallel with the duct itself. By connecting one end of the tracer wire to a signal generator, a detector unit above ground can be used to follow the route of the buried duct.

Various forms of duct assemblies including tracer wires are known. However, none of them is ideal, for example in terms of ease of manufacture, cost, or ease of use. One particular form of duct assembly having a tracer wire is disclosed in US 2016377503 A1 (Dura-Line). A different kind of assembly having a tracer wire firmly bonded to a polyethylene (PE) pipe is disclosed in CN106402510A. These and other known examples are described in more detail below, with reference to FIG. 2. In KR102151703B1, a tracer wire is placed against the pipe wall and attached using a conductive resin and covered by a coating of the same material as the pipe wall.

### SUMMARY OF THE INVENTION

The invention in aspects aims to provide a new form of duct assembly including a tracer wire. The invention in another aspect aims to provide a new method of manufacturing duct assemblies including tracer wires.

The invention in a first aspect provides a duct assembly comprising a duct having an outer wall of polymer material, an insulating jacket coupled to the pipe, and a tracer wire within the insulating jacket, wherein the insulating jacket is generally round in cross-section and is attached directly to the outer wall of the duct without the use of adhesive.

In some embodiments, the attachment of the insulating jacket to the outer wall of the duct is such that the insulating jacket and tracer wire can be peeled from the outer surface of the duct, without leaving significant residue or deformation of the duct surface.

A thickness of the insulating jacket may be similar to or greater than a diameter of the tracer wire. For example, the tracer wire may be a copper wire of diameter approximately 1 mm or less, for example AWG 18, AWG 20, or AWG 22 (American wire gauge). A thickness of the insulating jacket, may be greater than 1 mm, for example greater than 1.2 mm.

In a practical embodiment, the insulating jacket is made of a thermoplastic polymer material and is attached to the outer wall of the duct by pressing together the outer wall of the duct and the insulating jacket while the polymer material of the insulating jacket is at or close to its melting point.

To facilitate attachment of the insulating jacket to the outer wall of the duct, both of these parts may be made of similar base polymer material. For example, both parts may be made of polyethylene, or polypropylene, or PVC, or polyamide, or EVA, or a fire-safe polymer such as LFH (tradename Megolon®). It will be understood that blends of polymers are to be considered as ‘similar’ in this context, provided one will readily fuse with the other at a suitable temperature. For example, one or other part may be a co-polymer of the same polymer and another polymer. For example, a co-polymer such as PE-EVA co-polymer may for practical purposes be considered similar to the base polymer PE. On the other hand, polymers which are incompatible and unlikely to bond are also known.

To facilitate attachment of the insulating jacket to the outer wall of the duct, the pressing together of the outer wall of the duct and the insulating jacket may be performed while a polymer material at an outer surface of duct is at an elevated temperature, but below its melting point.

To ensure that the insulated jacket can be peeled from the outer wall of the duct at a later date, the elevated temperature may be below a softening point of the polymer material of the outer wall of the duct.

For a polyethylene duct, for example, the elevated temperature may be in the range 70 to 120° C., for example in the range 70 to 90° C.

The insulating jacket may be formed by extrusion of molten polymer over the tracer wire.

Conveniently, the pressing together of the outer wall of the duct and the insulating jacket may be performed immediately after extruding the polymer material of the insulating jacket over the tracer wire.

The outer wall of the duct may be formed by extrusion of molten polymer material through an extrusion die, followed by a process of drawing down and cooling the polymer material to achieve a desired size and form of duct.

Conveniently, the pressing together of the outer wall of the duct and the insulating jacket may be performed immediately after an initial cooling and sizing stage after extruding the polymer material of the outer wall of the duct, but before a final cooling stage of the duct.

Conveniently, the duct assembly can be made in a single continuous process, wherein the duct including the duct outer wall is formed by extrusion of one or more polymer materials through a primary extrusion head, the insulated jacket is formed separately by extrusion of a molten polymer material through an auxiliary extrusion head downstream of the primary extrusion head, and the insulated jacket is attached to the outer wall of the duct downstream of the auxiliary extrusion head prior to prior to cooling the duct assembly and winding of the complete duct assembly onto a storage drum.

The present disclosure further provides a method of installing a duct assembly, wherein the duct assembly comprises a duct assembly having the features set forth above and wherein the method comprises directly or indirectly burying the duct assembly along a desired route, while keeping a first end of the duct and tracer wire accessible above ground, for use later in locating the buried duct.

The present disclosure further provides a method of locating a buried duct, wherein the buried duct is part of a duct assembly having the features set forth above and wherein the method comprises applying an electrical signal to an exposed part of said tracer wire, and detecting signals radiated from another part of the tracer wire, thereby locating the buried duct.

These and other aspects and features of the invention will be understood from consideration of the examples described below and the dependent claims, illustrated with the appended drawings.

### BRIEF DESCRIPTION OF THE DRAWINGS

Embodiments of the present invention are described below, by way of example only, with reference to the accompanying drawings, in which:

FIG. 1 illustrates the use of a tracer wire to locate a buried duct for connecting a domestic or business premises with a broadband access point;

FIG. 2 illustrates various known forms of duct assembly including tracer wires;

FIG. 3 illustrates three stages in the manufacture of a novel duct assembly made as one embodiment of the present invention;

FIG. 4 illustrates schematically an apparatus and method for manufacturing the duct assembly of FIG. 3;

FIG. 5 shows in more detail an auxiliary extrusion head producing an insulated jacket around a tracer wire in the apparatus of FIG. 4;

FIG. 6 illustrates the duct assembly in use, including peeling of the insulating jacket and tracer wire from an outer wall of the duct.

### DETAILED DESCRIPTION OF EXEMPLARY EMBODIMENTS

### Introduction

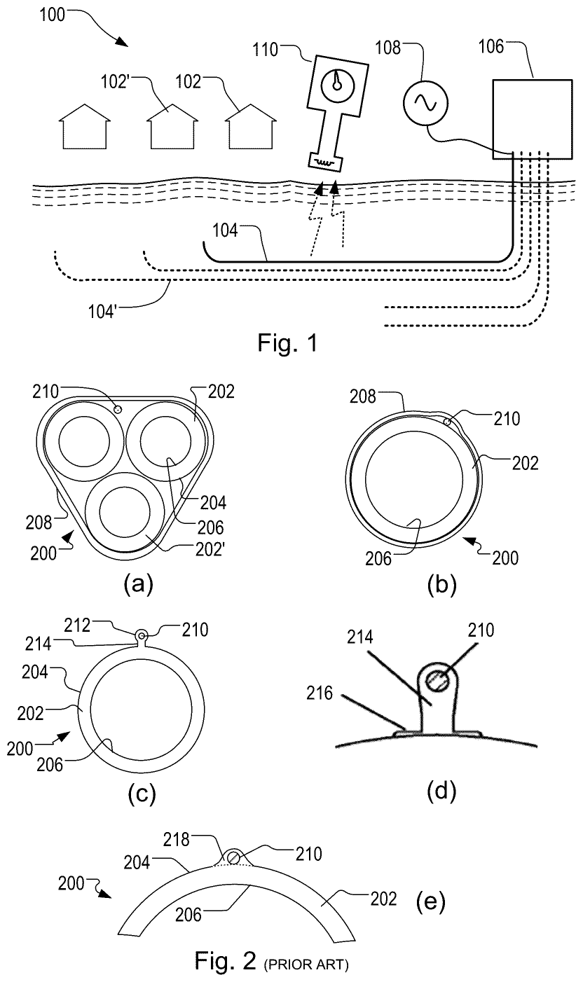

FIG. 1 is a schematic representation of a duct installation 100, by which cables (not shown) can be routed through a neighbourhood to various private and/or commercial and industrial premises 102, 102′. A number of ducts 104, 104′ etc have been buried in advance beneath the ground, either directly buried or installed in larger buried ducts. Cables carrying optical fibres and/or electrical conductors me be installed subsequently in the ducts, or may already be partially installed but not yet brought into use. The ducts 104 in this example all have a first end terminating at an access point 106, or example a street cabinet, or larger installation.

The ducts 104 are non-metallic, and lightweight optical fibre cables also are non-metallic. To allow the buried ducts to be located and excavated for connection to premises at a later date, each is provided as part of a duct assembly that includes a metal conductor or “tracer wire”. As shown, a signal generator 108 can be connected to the tracer wire at one end of the duct. Signals injected into the conductor emanate from the whole length of the tracer wire beneath the ground. A detector unit 110 is used to locate and follow the route of the duct assembly without disturbing the ground.

### Known Duct Assembly Examples

FIG. 2 illustrates in schematic cross-sections (a) to (d) a variety of known duct assemblies including tracer wires. In example (a), a duct assembly 200 comprises a plurality of individual plastic ducts 202, 202′, each having an outer surface 204 and an inner surface 206. Depending on their application, each duct may have a single layer, comprise multiple layers such as a low friction lining, and main wall layer, and layers for reinforcement, colour, stripes etc. These details are immaterial for the purposes of the present disclosure. The individual ducts 202 in this example are formed into a bundle, enclosed within an outer sheath 208. A tracer wire 210 is included in one of the interstices between the ducts and the outer skin.

In example (b), a single duct 202 is provided with a tracer wire 210, held against an outer wall of the duct by an outer sheath 208. It is a matter of design choice whether the tracer wires 210 in these examples (a) and (b) are bare copper conductors, or are provided with insulating jackets. The ducts 202 in examples (a) and (b) are typically microducts with outer diameter up to 16 mm, and often as small as 5 mm or 7 mm.

Example (c) shows a known form of duct assembly, described as prior art in US 2016377503 A1 (Dura-Line). In this assembly, a single duct is shown, which may be larger than microducts typically included in the examples (a) and (b), for example 15 or 20 mm or greater. The tracer wire 210 is located on the outside of the duct assembly, within its own insulating jacket 212. Insulating jacket 212 is attached to an outer wall 204 of the duct 202 via an “attachment base” 214.

Example (d) shows a modified version of such a duct assembly according to further teaching of US '503. According to this teaching, the insulating jacket is attached to the wall of the duct via a T-shaped attachment base 214, having a wider portion 216 for a more secure attachment. Attachment may be for example by adhesive, so that the tracer wire including the attachment base 214/216 can be peeled from the duct wall when joining sections of duct into a longer pipeline.

Example (e) shows another known form of duct assembly, disclosed in CN106402510A, mentioned above. In this assembly, a single polyethylene (PE) duct 202 is shown in partial cross-section. During manufacture, the tracer wire 210 is pressed against the outer wall 204 of the duct 202 and a PE melt adhesive 218 is extruded over the wire. According to the teaching of CN '510, the tracer wire 210 and melt adhesive 218 are added to the duct wall after the latter has been vacuum-sized but before it is cooled. In this way, melt adhesive 218 and the duct wall become one, and the tracer wire becomes firmly bonded to the duct.

### Novel Duct Assembly Example

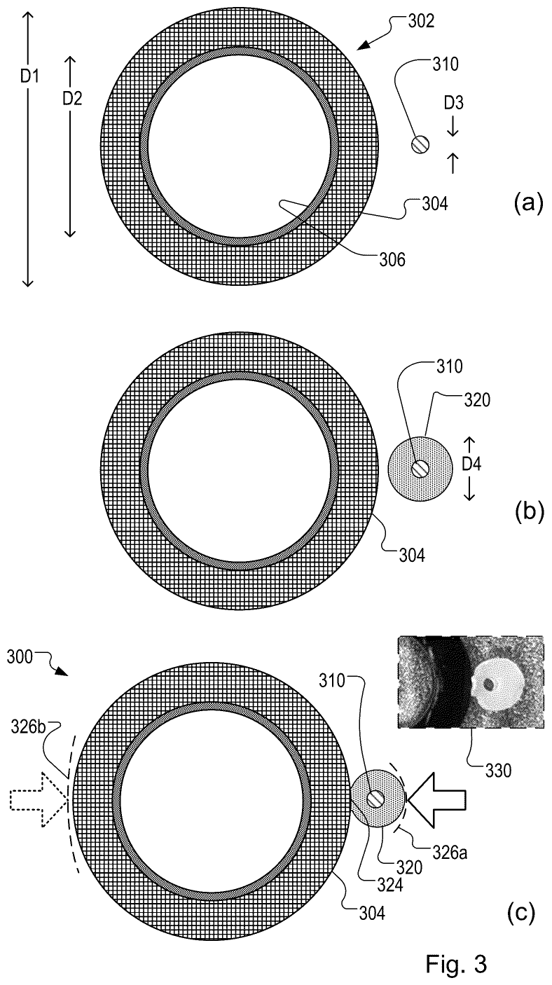

FIG. 3 shows at (a), (b) and (c) three stages in the manufacture of a novel duct assembly, according to the present disclosure. As will be explained later, this duct assembly can be produced in a single continuous process, with only minor modification of a conventional extrusion production line used to form whatever kind of duct is required.

For the purposes of FIG. 3, the duct 302 and tracer wire 310 are shown simply in schematic cross-section. Duct 302 has an outer diameter D1 and an inner diameter D2. The duct in this example comprises an outer wall 304 and a thinner lining 306. Both of these layers are extruded from a molten polymer material. The material of the lining may have additional additives, for example to reduce friction and/or static electricity so as to improve installation of cables by pushing, pulling and/or blowing through the duct. Other features may be provided within the duct body, or within the inner bore, for example a pre-installed cable, or a pre-installed pulling line. These variations are all within the general knowledge of the skilled person, but have no bearing on the substance of the present disclosure.

Tracer wire 310 is shown lying a short distance from the outer wall 304 of duct. The wall of the duct may have a diameter of 1, 1.5, 2 or more millimetres. The conductor forming tracer wire 310 may have a diameter D3 of approximately 1 mm or less.

In view (b), an insulating jacket 320 has been applied to the tracer wire, with a diameter D4 several times larger than the diameter of the tracer wire itself. A thickness of the insulating jacket, may be greater than 1 mm, for example in the range 1.2 to 1.5 mm. Thus, the diameter D4 of the insulating jacket, may be more than 2.5 mm, for example 3 or 3.5 mm.

In view (c), pressure is applied to attach the insulating jacket 320 to the outer wall 304 of duct 302. According to the methods of manufacture disclosed herein, this pressing together is performed while the polymer material of the insulating jacket is substantially molten. By appropriate selection of compatible materials, and by controlling the temperature of the insulating jacket material, but also the outer wall of 304 of the duct itself, a secure bond 324 between these parts can be achieved, without damaging the outer wall of the jacket. Furthermore, while the bond is secure enough to prevent the insulating jacket and tracer wire from becoming detached from the duct during normal storage, handling and installation, the insulating jacket and tracer wire can be peeled from the duct leaving little or no residue or indentation.

Providing such a thick insulating jacket reduces the risk that the tracer wire breaks through the molten jacket material during the pressing operation. The pushing together of the insulating jacket and the outer wall of the duct may be performed using one or more concave pushing tools 326, 328, so as to distribute pressure over a surface of the molten insulated jacket.

It will be understood that pressing too hard or too far on the molten/semi-molten material of the insulating jacket 320 could cause the tracer wire simply to push through the material and lose its insulating cover. However, by careful control of temperatures and forces, and by aligning arranging the tracer wire 310 to have a very narrow approach angle, and by the use of suitably chosen pushing surfaces, it has been found that the desired product can be made reliably. The inset photograph 330 is a magnified cross-section of one manufactured sample, in the vicinity of the insulating jacket and bond 324. Contrast between the black-pigmented the non-coloured insulating jacket allows the form of both to be seen. (The tracer wire 310 has been removed, leaving an empty hole through the sliced insulating jacket.)

### Manufacturing Method and Apparatus Example

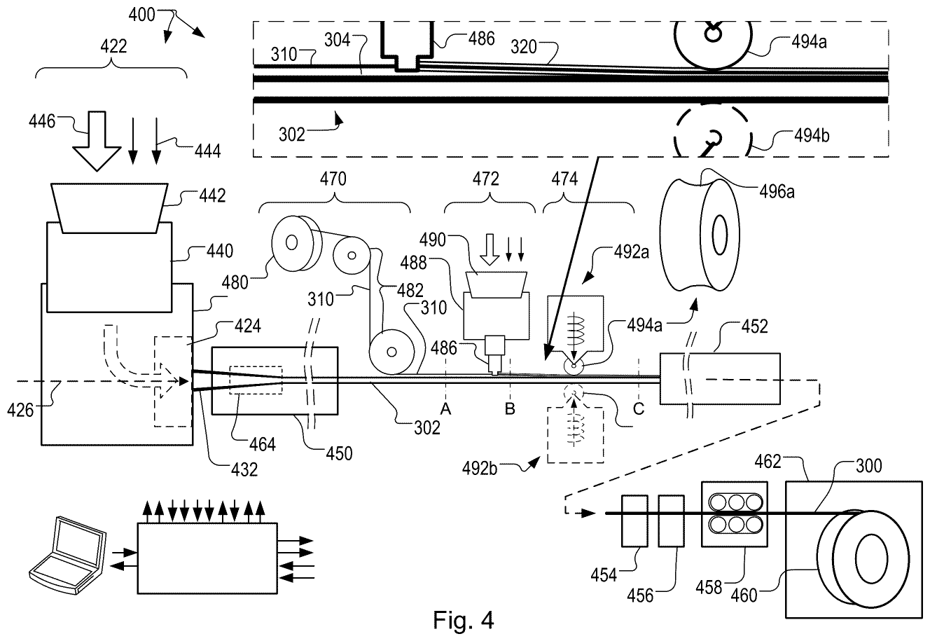

FIG. 4 illustrates schematically an apparatus 400 and processing steps used to manufacture the duct assembly 300 in one embodiment of a method of manufacture. As a general remark, it should be noted that this schematic presentation does not represent different elements in common scale, or proportion. Nor are the various components of the apparatus presented in any common orientation or viewpoint. For example, the view presented at one stage of the production line may be effectively a plan view, and in another part of the production line it may be more likely a side view of the practical arrangement. The whole production line may be tens of metres in length.

Manufacture of duct 302 is initiated at a primary extrusion station 422. Within the primary extrusion station 422, a primary extrusion head 424 is shown only as a block. The exact form of the extrusion head will depend on details of the product being made, such as the number of layers, and any additional features such as strength elements, striping and so forth. One or more feed-through paths 426 can be provided for additional elements such as strength members, pulling lines, or even pre-installed cables. These matters are within the normal competence of the person skilled in the art and need not be explained further here. From an output side of primary extrusion head 424, a hot polymer tube 436 is delivered for subsequent processing to form the finished duct assembly 300.

To deliver molten polymer to extrusion head 424, a multistage heater and compression/mixing unit 440 is provided within primary extrusion station 422. This is fed by a hopper 442 which receives polymer materials in the form of pellets in a conventional manner. These pellets may already be pre-mixed with the desired combination of additives to form the material of the duct outer wall 304 and/or other layers. Alternatively, one or more additives 444 may be supplied to the hopper in pellet form along with pellets of base polymer 446. An example where mixing of an additive is deferred until this stage would be where a cross-linked polymer material is desired. For other types of additives, it may be a matter of choice whether premixing in the pellets is desired, or mixing of pellets into the hopper.

The skilled person will understand how to adjust the machine settings, particularly temperatures and pressures according to the melting and flow properties of different polymer sheath materials such as polyethylene (HDPE, LDPE, MDPE), polypropylene (PP), polyamide (PA; nylon), LFH (Megolon®). Extrusion rate and pressure on the molten polymer material supplied to the extrusion head 424 can be controlled by the design and operating speed of the extruder screw, which typically both mixes and compacts the molten polymer before forcing it through the extrusion head.

Downstream of extrusion head 424, a series of cooling tanks 450, 452 are provided, from which the duct assembly 300 emerges more or less in its finished form. It will be understood that these tanks are shown in truncated form, for reasons of space. In practice, each tank may be several metres long. Each cooling tank comprises essentially a bath of water at a controlled temperature. The first cooling tank 450 includes additional features, mentioned below. The production line optionally includes a monitoring station 454 and/or printing station 456. A puller 458 of caterpillar or similar design applies the tension to draw all the elements of the cable from the bobbins 402, 404, through all of the process steps until the finished duct assembly 300 is wound on a drum 460 mounted in a take-up unit 462. Take-up unit 462 will typically perform swapping-in and out of a succession of drums (not shown), so that many kilometres of duct assembly can be produced without interruption.

As the skilled person will know, the hot polymer tube 432 that emerges from the extrusion head has inner and outer diameters larger than those of the duct 302 in the finished duct assembly. In a manner well known, the process parameters of all the illustrated units are controlled to draw and cool the polymer tube, giving it the interior and exterior dimensions of the finished duct 302. The first cooling tank 450 in this example includes a series of sizing dies indicated schematically at 464. A slight vacuum is also applied, so that the tube is guided to a desired size by the time it emerges from the tank 450.

The temperature in the first cooling tank is an elevated temperature, for example in the range 70 to 90° C., so that the outer surface of the duct is no longer molten, and is below a softening point of the particular polymer material being used (for example, below 120° C. for polyethylene). On the other hand, below the surface the material may be hotter, and even still molten.

A computerised control system 470 is illustrated schematically, which receives many sensory inputs, for example from temperature sensors (e.g. thermocouples), pressure sensors and the like, and controls power to the several heaters, coolers that are distributed throughout the apparatus. It is a matter of design choice to what extent automated feedback control is provided, and to what extent manual adjustment is relied upon. Operation of certain parts such as the extrusion station 422 may be controlled by dedicated subsystems within the overall control system 470. Many local feedback control loops will be implemented, for example to control the puller 458, and the take-up unit 462. Such feedback control can be automated, of course with regard to the substantial time lag between any adjustment being made and the effect of that adjustment being apparent in the finished product.

At some point between the second cooling tank 452 and the take-up unit 462, such as monitoring station 454, parameters such as the outer diameter of the produced duct 302 are measured, to ensure that the product is within specification. If the diameter looks like exceeding the maximum specified value, measures can be taken, for example, to accelerate the drawing of the cable by puller 458, and/or to reduce the flow of polymer material into the hot polymer tube 432, or a combination of these.

### Forming and Attaching Tracer Wire With Insulating Jacket

For the production of the insulating jacket 312 of the duct assembly 300, and its attachment to the outer wall of the duct 320, additional apparatus is included in the production apparatus 400, as will now be described. Section lines A, B and C correspond to the cross-sectional views of FIGS. 3(a), (b) and (c), respectively. An enlarged detail of the relevant part of the production line is inset at the top of the drawing.

For ease of reference, the additional apparatus may be considered as a wire feed station 470, an auxiliary extrusion station 472 and an attaching station 474. For the control of the wire feed station 470 auxiliary extrusion station 472 and attachment station 474, additional monitoring and control functions are implemented in the control system 700 and/or dedicated control subsystems, beyond the normal functions associated with production of a simple duct.

In wire feed station 470, a bobbin 480 delivers a supply of copper wire to form the tracer wire 310. The bobbin 480 is controlled to apply a certain back tension while its payload is drawn off progressively to form the duct assembly. One or more pulleys and guides 482, guide the bare wire from its source on the bobbin into alignment with the still-warm duct 320, spaced by only a few millimetres as shown in FIG. 3(a).

In auxiliary extrusion station 472, an auxiliary extrusion head 486 receives the trace wire and applies molten polymer material to form the insulating jacket 320. In the same way as described above for the primary extrusion station 422, multistage heater and compression/mixing unit 488 is fed with solid polymer pellets from a hopper 490. These pellets may already be pre-mixed with colour and/or other additives to form the material insulating jacket 320. Alternatively, one or more additives may be supplied to the hopper in pellet form along with pellets of base polymer.

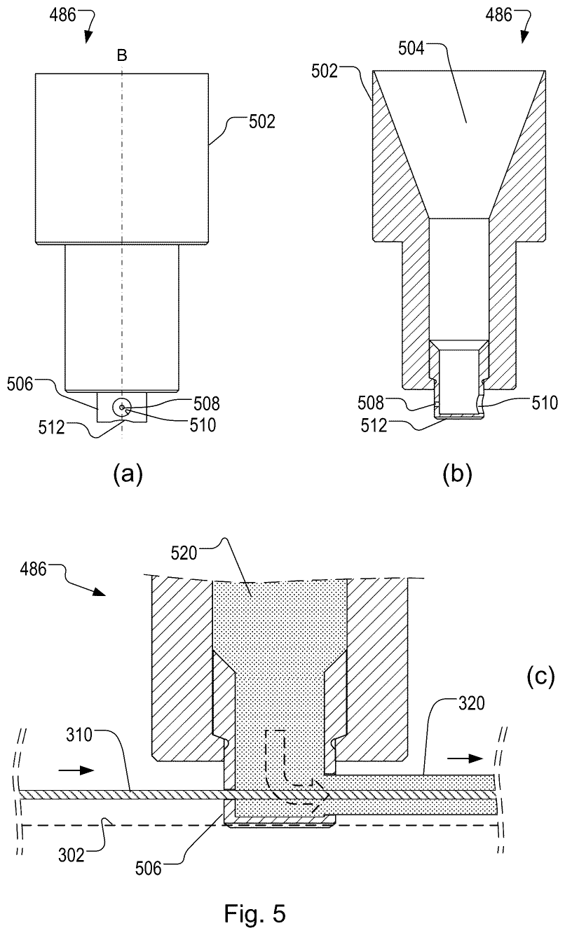

FIG. 5 illustrates an example form of auxiliary extrusion head 486 in more detail. FIG. 5(a) is an external view, looking in an upstream direction, parallel to the duct axis. FIG. 5(b) is a cross-sectional view showing internal structure, looking in the same direction as the view in FIG. 4. FIG. 5(c) is an enlarged detail of the same cross-section, operating to form an insulating jacket 320 around a tracer wire 310.

As seen in views (a) and (b), auxiliary extrusion head comprises a generally cylindrical metal body 502 having an internal chamber 504 for receiving molten polymer material. The small size of the auxiliary extrusion head means that no independent heating is required within it. Chamber 504 communicates with the interior of an extrusion tip 506. Extrusion tip 506 has a small input aperture 508 for receiving tracer wire 310 and a larger output aperture 510 for emission of the tracer wire with insulating jacket 320 surrounding it, albeit still in molten form. An end surface 512 of the extrusion tip is formed with a concave shape, to allow the apertures to be positioned as close as possible to the outer wall 304 of duct 302 as it passes by.

Referring now to FIG. 5(c), will be seen how molten polymer material 520 (received from multistage heater and compression/mixing unit 488) flows into the extrusion tip 506 and onto the tracer wire 310, to form the thick insulating jacket 320.

Returning to FIG. 4, attaching station 474 comprises one or more pushing arrangements 492a and 492b. These arrangements function to push very gently on the molten insulating jacket 320, and/or to push gently on the duct 302, so that they come into contact as seen at FIG. 3(c). The insulating jacket is still molten, though it may have time to form a thin skin before contacting the pushing arrangement. As mentioned above, at least an outer surface 304 of duct 302 is effectively solid, but still at an elevated temperature. If desired, the environment between the extrusion station 472 and attaching station 474 can be passively and/or actively controlled to condition the surface of the insulating jacket before it is engaged by contact surfaces in the attaching station.

In this example one or more ceramic rollers 494a and 494b are provided to push on the parts 302, 320, with curved contact surfaces 496a to distribute forces. Other static or moving contact surfaces can be used, of course. The curvature of the contact surfaces can be adapted to the different diameters of the parts 302 and 320, if desired. Coatings on the rollers or other contact surfaces can be selected to achieve the desired pushing force without spoiling the surface of the insulating jacket with adhesion or rubbing.

As mentioned already, good results have been obtained by arranging that the insulating jacket material is substantially molten, with possibly a thin skin forming, while at least an outer portion of the duct material is an elevated temperature, but solid. As also mentioned, the polymers of the two parts are chosen to be generally compatible. Under these conditions, the insulating jacket adheres robustly to the surface of the duct, without the surface of the duct itself being significantly deformed.

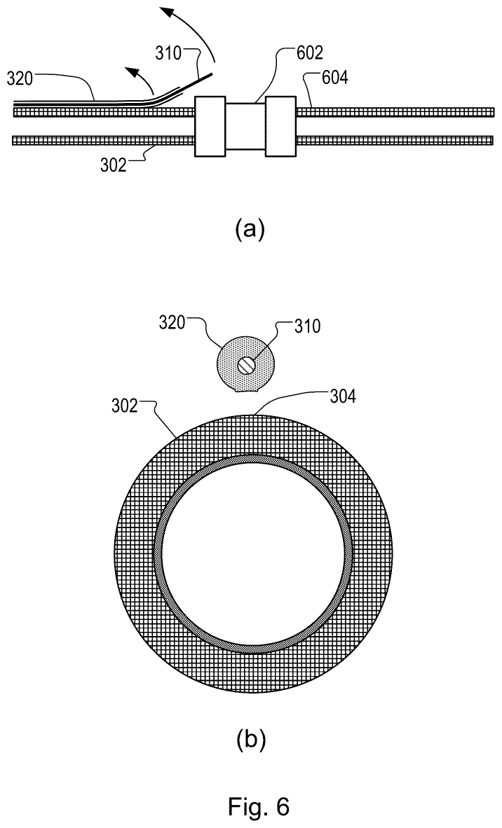

As illustrated in FIGS. 6(a) and (b), examples made according to the present disclosure allow the tracer wire and insulating jacket to be removed from the duct surface with little or no residue, and with little or no residual deformation or degradation of the outer surface of the duct. Peeling as illustrated in FIG. 6(a) is a simple operation, leaving the duct surface ready for fitting accessories. As an example, a coupler 602 can be directly fitted to connect duct 302 to another duct 604. The tracer wire 310 remains with its insulating jacket 320 intact throughout, being peeled as a single unit from the surface of the duct. Access to the bare conductor or tracer wire 310 is by the same method as stripping conventional insulated wire, so that it may be jointed and/or connected to the signal generator very easily, without special tools or techniques.

FIG. 6(b) illustrates what is found in practice. The insulating jacket deforms itself slightly when bonding to the outer surface 304 of the duct 302, but the surface of the duct is not significantly marked.

Routine experimentation can determine the best settings according to the particular materials involved and product dimensions, the rate of production, the threshold of force required for peeling, and other parameters. If the duct surface gets too hot, at or close to the softening point of its constituent polymer material, then an irreversible fusing of the two materials is likely to result. The result may be a product that has utility, but the advantage of ‘peelability’ would be lost. Conversely, if the surface of the duct is too cold upon contact with the material of the insulating jacket, then the latter will solidify without bonding securely enough to the duct.

Positions and forces on the contact surfaces can be passively or actively controlled, using actuators, springs, magnets and so forth. Coatings and temperatures of the rollers or other contact surfaces can be selected and actively controlled, if necessary, to achieve the desired pushing force without spoiling the surface of the insulating jacket, and without causing the tracer wire 310 to be overly displaced in the molten material. Non-contact methods of pressing the parts together, such as fluid pressure, can be deployed, as an alternative or addition to mechanical contact.

### Conclusion

The present disclosure provides a number of novel products, tools and processes, each of which may be used independently and/or in combination with one another. The production can be speedier and cheaper, with more efficient use of materials, than the known forms of duct assembly illustrated in FIG. 2. The need for additional sheath layers or complex die shapes is avoided. The profile of the tracer wire above the duct surface is minimised, allowing it to flex and be used without becoming detached or catching on other parts. There is no need for adhesive. Peeling is a simple operation, leaving the duct surface ready for connecting to other ducts or accessories. The tracer wire and its insulating jacket can be peeled from the duct as a unit.

While it is an advantage of the invention in its various embodiments that the production can be performed with very high volumes in a continuous process, the present disclosure also encompasses embodiments in which production is performed as a series of the duct and the insulating jacket are performed separately, and these components brought together at a later time to form the finished duct assembly. That said, it will be appreciated that additional arrangements would be required to bring one or both components to the desired temperature before the attaching step. By contrast, the method of manufacture disclosed above very efficiently exploits the temperate profiles inherent in manufacture of ducts and duct assemblies by extrusion.

While specific embodiments of the present invention have been described above, it will be appreciated that departures from the described embodiments may still fall within the scope of the present invention, defined by the appended claims and their equivalents.

1. A duct assembly comprising a duct having an outer wall of polymer material, an insulating jacket coupled to the pipe, and a tracer wire within the insulating jacket, wherein the insulating jacket is generally round in cross-section and is attached directly to the outer wall of the duct without the use of adhesive.

2. A duct assembly as claimed in claim 1 wherein the attachment of the insulating jacket to the outer wall of the duct is such that the insulating jacket and tracer wire can be peeled from the outer surface of the duct.

3. A duct assembly as claimed in claim 1 wherein a thickness of the insulating jacket is similar to or greater than a diameter of the tracer wire around at least half of its circumference.

4. A duct assembly as claimed in claim 3 wherein the tracer wire is a wire of diameter 1.1 mm or less, and a thickness of the insulating jacket is greater than 1.2 mm around at least half of its circumference.

5. A duct assembly as claimed in claim 1 wherein the insulating jacket is made of a thermoplastic polymer material and has been attached to the outer wall without adhesive.

6. A duct assembly as claimed in claim 1 wherein the insulating jacket and the outer wall of the duct are made of similar base polymer materials, whereby the material of the jacket when molten will bond reversibly to the material of the duct when the latter is at a temperature below its softening point.

7. A method of manufacturing a duct assembly, the duct assembly comprising a duct having an outer wall of polymer material, an insulating jacket coupled to the pipe, and a tracer wire within the insulating jacket, wherein the insulating jacket is generally round in cross-section and is attached directly to the outer wall of the duct without the use of adhesive.

8. A method as claimed in claim 7 wherein the attachment of the insulating jacket to the outer wall of the duct is such that the insulating jacket and tracer wire can be peeled from the outer surface of the duct at a later date.

9. A method as claimed in claim 7 wherein a thickness of the insulating jacket is similar to or greater than a diameter of the tracer wire around at least half of its circumference.

10. A method as claimed in claim 9 wherein the tracer wire is a wire of diameter 1.1 mm or less and a thickness of the insulating jacket is greater than 1.2 mm around at least half of its circumference.

11. A method as claimed in claim 7 wherein the insulating jacket is made of a thermoplastic polymer material and is attached to the outer wall of the duct by pressing together the outer wall of the duct and the insulating jacket while the polymer material of the insulating jacket is at or close to its melting point.

12. A method as claimed in claim 7 wherein the insulating jacket and the outer wall of the duct are both made of similar base polymer material.

13. A method as claimed in claim 7 wherein the pressing together of the outer wall of the duct and the insulating jacket is performed while a polymer material at an outer surface of the duct is at an elevated temperature, but below its melting point.

14. A method as claimed in claim 13 wherein said the elevated temperature of the material at the outer surface of the duct is below a softening point of the polymer material of the outer wall of the duct.

15. A method as claimed in claim 7 wherein the insulating jacket is formed by extrusion of molten polymer over the tracer wire.

16. A method as claimed in claim 15 wherein the pressing together of the outer wall of the duct and the insulating jacket is performed as part of a continuous process immediately after extruding the polymer material of the insulating jacket over the tracer wire.

17. A method as claimed in claim 7 wherein the outer wall of the duct is formed by extrusion of molten polymer material through an extrusion die, followed by a process of drawing down and cooling the polymer material to achieve a desired size and form of duct.

18. A method as claimed in claim 17 wherein the pressing together of the outer wall of the duct and the insulating jacket is performed immediately after an initial cooling and sizing stage after extruding the polymer material of the outer wall of the duct, but before a final cooling stage of the duct.

19. A method as claimed in claim 7 wherein the duct assembly is made in a single continuous process, wherein the duct including the duct outer wall is formed by extrusion of one or more polymer materials through a primary extrusion head, the insulated jacket is formed separately by extrusion of a molten polymer material through an auxiliary extrusion head downstream of the primary extrusion head, and the insulated jacket is attached to the outer wall of the duct downstream of the auxiliary extrusion head prior to cooling the duct assembly and winding of the complete duct assembly onto a storage drum.

20. A method of installing a duct assembly, wherein the duct assembly comprises a duct assembly as claimed in claim 1, and wherein the method comprises directly or indirectly burying the duct assembly along a desired route while keeping a first end of the duct and tracer wire accessible above ground, for use later in locating the buried duct.

21. A method of locating a buried duct, wherein the buried duct is part of a duct assembly as claimed in claim 1, and wherein the method comprises applying an electrical signal to an exposed part of said tracer wire and detecting signals radiated from another part of the tracer wire, thereby locating the buried duct.

22. A method of installing the duct assembly of claim 1, wherein the method comprises directly or indirectly burying the duct assembly along a desired route, while keeping a first end of the duct and tracer wire accessible above ground, for use later in locating the buried duct.

23. A method of locating a buried duct, wherein the buried duct is part of a duct assembly as claimed in claim 1, and wherein the method comprises applying an electrical signal to an exposed part of said tracer wire, and detecting signals radiated from another part of the tracer wire, thereby locating the buried duct in the vicinity of said other part of the tracer wire.
